(19) United States
(12) Patent Application Publication
(10) Pub. No.: US 2008/0285269 A1
(43) Pub. Date: Nov. 20, 2008

(54) Led Lamp

(76) Inventor: Sze Keun Chan, Hong Kong (CN)

Correspondence Address: KEVIN J. MCNEELY, ESQ., 5335 WISCONSON AVENUE, NW, SUITE 440, WASHINGTON, DC, 20015, US

(21) Appl. No.: 11/572,658

(22) PCT Filed: Sep. 26, 2005
(86) PCT No.: PCT/CN05/01562

§ 371 Date: Jan. 25, 2007

(30) Foreign Application Priority Data
Sep. 27, 2004 (CN) 200410078393.4

(51) Int. Cl. F21V 23/00

(52) U.S. Cl. 362/235

(57) ABSTRACT

An LED lamp includes a lamp-lid, a metal lamp-cup, an insulating layer for connecting a lamp-cap and the metal lamp-cup, LEDs, a semispherical pallet or an astigmatism plate, and a PCB (Printed Circuit Board) in the metal lamp-cup, characterized in that, one semispherical pallet is provided on said PCB, the semispherical pallet has the same number of holes as that of the LEDs, the LEDs are installed in the holes of the semispherical pallet, electrical connections of the LEDs are connected to the PCB through the semispherical pallet, and provided with power. The LEDs installed in this way are mounted on the semispherical pallet and arranged in a semisphere, thus light of the LEDs is radiated in various directions, increasing the light emitting angle of the LEDs, or the semispherical pallet is replaced by the astigmatism plate made of transparent or subtransparent material, the said metal lamp-cup is a larger area lamp cup made of metal or heat conduct materials; thus facilitating the heat emission of the LED lamp.

### CROSS-REFERENCE TO RELATED APPLICATION

This application is a U.S. national phase entry of international application number PCT/CN2005/001562 with international filing date of Sep. 26, 2005 and claims priority to Chinese application serial number 200410078393.4 filed on Sep. 27, 2004.

### TECHNICAL FIELD

This invention relates to LED lamp and more particularly to a lamp, which has metal lamp-cup with electroplated reflecting film and LEDs are arranged in semi-sphere.

### BACKGROUND ART

LEDs (light-emitting diode) have advantages such as very long life times, lighting-efficiency, zero radiation, vibration-proof and low power consumption. Because it is power saving, green and environmentally beneficial over other lighting sources, more and more lamps use LED lighting sources. In conventional LED lamps, most lamp-cups were made of glass or plastics, which are not good heat emission materials. Moreover, glass adds to the weight to the lamp, while it cannot assist the LED lighting sources. Also conventional LED lamps are arranged in the same level in a matrix and the transparent lamp-lid is typically close to the LEDs, both of which may hinder the ability to emit light. Typically, the lamp-lid and lamp-cup are glued together, which is easy to loosen due as the materials age due to heating and cooling cycles.

### DISCLOSURE OF INVENTION

Therefore, an object of the invention is to provide a kind of LED lamp, which has a metal lamp-cup with electroplated reflecting film and LEDs that are arranged in a semi-sphere. It is characterized in strong light reflection, large luminous flux and a wide light emitting angle.

Another object of the invention is to resolve the heat-emitting issue of high luminous flux LEDs.

Yet another object of the invention is to resolve the heat-aging issue which causes loosening of the glued border between the LED lamp-lid and lamp-cup.

These objects are accomplished, in one aspect of the invention, by a lamp-lid, a metal lamp-cup, an insulating layer for connecting a lamp-cap and the metal lamp-cup, LEDs, a semispherical pallet or an astigmatism plate, and a PCB (Printed Circuit Board) in the metal lamp-cup, characterized in that, one semispherical pallet is provided on the PCB, the semispherical pallet has the same number of holes as that of the LEDs, the LEDs are installed in the holes of the semispherical pallet, electrical connections of the LEDs are connected to the PCB through the semispherical pallet, and provided with power.

The LEDs are mounted on the semispherical pallet and arranged in a semispherical arrangement, thus light of the LEDs is radiated or scattered in various directions, increasing the light emitting angle of the LEDs. While the semispherical pallet is made of transparent or subtransparent materials, the LED chips could be installed in the semispherical pallet and also arranged in a semisphere. The LED chips are connected in series by electrical connections with the PCB, and when powered, the LED chips radiate light through the transparent or subtransparent semispherical pallet.

In another other aspect of the invention, the metal lamp-cup has a much larger area made of metal or other heat conductive materials. The inner surface of the lamp-cup is electroplated or welded with reflecting film. Thus, light from the LEDs is reflected by the reflecting film, and the light is brighter and more equitably distributed. The metal lamp-cup with inner reflecting film resolves the heat-emitting issue of high luminous flux LEDs, facilitating both light and heat emission of the LED lamp.

On Sep. 1, 2004, the applicant applied for a utility patent (number: 200420093010.6) and PCT, titled LED lamp, in which the astigmatism plate can be implemented with the invention. The astigmatism plate is made of transparent or subtransparent materials, such as, colophony, etc. The plate has the same number of holes as that of LEDs and they are integrated into one entity so that the light of the LEDs is radiated or scattered in various directions, increasing the light emitting angle of the LEDs.

In another aspect of the invention, the lamp-lid is made of transparent or subtransparent material, the lamp-lid and lamp-cup have the same number and position of holes, through which, the lamp-lid and lamp-cup can be secured tightly by bolts and nuts to avoid loosening. This resolves the heat-aging issue of a glued border between lamp-lid and lamp-cup. And, because of the large reflection area of the lamp-cup and the space between the lamp-lid and the LEDs, the light from the LEDs can be effectively and uniformly reflected and emitted.

In another aspect of the invention, there is an electrical insulating layer between the lamp-cap and the metal lamp-cup. The insulating layer is made of electrically non-conductive fictile materials, such as, ceramic or plastic.

Because of the semi-spheric arrangement of LEDs and/or the integration of the astigamatism plate and the LEDs, and the large area metal lamp-cup with a reflecting film, a more uniform and efficient lighting source is achieved the heat-emitting issue of high luminous flux LEDs is minimized.

For a better understanding of the present invention, the objects, characteristics and advantages of the invention are illustrated in the description and the drawings.

### BRIEF DESCRIPTION OF THE DRAWINGS

FIG. 1 is a perspective view of a best embodiment of the LED lamp invention.

FIG. 2 is a perspective view of an alternate embodiment of the LED lamp invention.

FIG. 3 is a perspective view of interconnecting mode of LEDs and semi-spherical pallet of the LED lamp invention.

FIG. 4 is a perspective view of interconnecting mode of lamp-cap and lamp-cup of the LED lamp invention

### DETAILED DESCRIPTION

FIG. 1 shows a lamp-lid (1); metal lamp-cup (2); an insulating layer (6) for connecting a lamp-cap (7) and the metal lamp-cup (2); and LEDs (3), a semispherical pallet (4), and printed circuit board (PCB) (5) in the metal lamp-cup (2); characterized in that a semi-spherical pallet (4) is provided on the PCB (5), the semispherical pallet (4) has the same number of holes as that of the LEDs (3), the LEDs (3) are installed in the holes; and electrical connections (31) of the LEDs are connected to the PCB (5) through the semispherical pallet (4). The LEDs (3) installed in this way are mounted on the semispherical pallet (4) and arranged in a semisphere. Thus, light of the LEDs (3) is radiated in various directions, increasing the light emitting angle of the LEDs.

FIG. 3 is a perspective view of LEDs (3) interconnected with the semispherical pallet (4). As shown in FIG. 3b, while the semispherical pallet is made of transparent or subtransparent materials and the LED chips (32) can be installed into the semi-spherical pallet (4). The LEDs chips (32) are semi-spherically installed into the semispherical pallet (4) and are connected in series by the electrical connections (33) which are connected to the PCB (5). Thus, when the power is on, the LED chips (32) emit light through the transparent or subtransparent semispherical pallet(4).

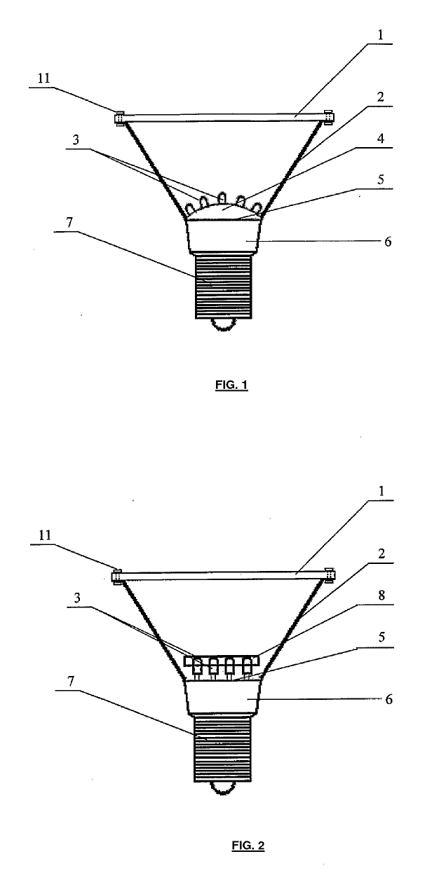

FIG. 2 shows a lamp-lid (1), metal lamp-cup (2), an insulating layer (6) for connecting a lamp-cap (7) and the metal lamp-cup (2), LEDs (3), an astigmatism plate (8), and a PCB (5) in the metal lamp-cup (2), characterized in that, an astigmatism plate (8) is provided on the PCB (5). The astigmatism plate (8) is made of transparent or subtransparent materials, such as, colophony, etc. The astigmatism plate has the same number of holes as that of the LEDs (3) and they are integrated into one entity above the PCB (5). In this way, light of the LEDs is radiated or scattered in various directions, increasing the light emitting angle of the LEDs.

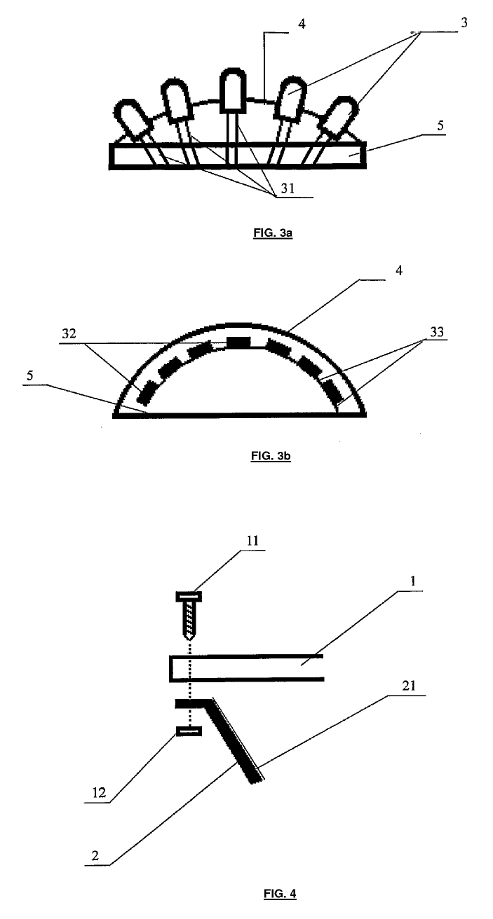

As shown in FIG. 4, the invention uses a metal lamp-cup (2). The metal lamp-cup (2) has a larger area lamp cup made of metal or other heat conductive materials. The inner surface of lamp-cup (2) is electroplated or welded with a reflecting film(21) which facilitates both light and heat emission of the LED lamp. This resolves the heat-emitting issue of high luminous flux LEDs.

The lamp-lid (1) is made of a transparent of subtransparent material and the lamp-lid (1) and lamp-cup (2) have same number and position of holes, through which, the lamp-lid (1) and lamp-cup (2) can be secured tightly by bolts (11) and nuts (12) to avoid loosening. And because of the large reflection area of the lamp-cup (2) and the space between lamp-lid (1) and the semi-spherically installed LEDs (3), the LED light from different directions is reflected by the lamp-cup (2) and the inner reflecting film (21), thus, more uniform and effective light source can be achieved.

In another aspect of the invention, there is an electrically insulating layer between the lamp-cap (7) and the metal lamp-cup (2). The layer (6) is made of insulating materials, such as, fictile materials, plastics, etc. The lamp-cap (7) can be either an Edison socket or a swan socket depending on needs.

The invention uses a structure and materials that are beneficial to large scale production and has great commercial potential.

While various embodiments of the invention have been shown and described, it will be apparent to those skilled in the art that various changes and modification can be made without departing from the scope of the invention as defined by the following claims.

What is claimed is:

1. An LED lamp comprising:
a lamp-lid;
a metal lamp-cup, the metal lamp-cup being made of a heat conductive material such as metal and the inner surface of the lamp-cup being electroplated with reflecting film;
an insulating layer to connect a lamp-cap and the metal lamp-cup;
LEDs;
a semi-spherical pallet or an astigmatism plate;
a PCB (Printed Circuit Board) in the metal lamp-cup; and
a semi-spherical pallet on the PCB, the semi-spherical pallet having the same number of holes as that of the LEDs, the LEDs being installed in the holes with the electrical connections of the LEDs are connected to the PCB through the semispherical pallet and provided with power, or
an astigmatism plate on the PCB, wherein the astigmatism plate includes a transparent or subtransparent material, and the astigmatism plate has the same number of holes as that of the LEDs, the LEDs are installed in the holes with the electrical connections of the LEDs connected to the PCB.

2. The LED lamp of claim 1, wherein the LEDs and the semi-spherical pallet or the astigmatism plate are installed in and at the bottom of the metal lamp-cup.

3. the LED lamp of claim 1, further comprising:
a transparent or subtransparent lamp-lid.

4. An LED lamp of claim 1, wherein the combining border of the lamp-lid and the lamp-cup has screw holes, through which, the lamp-lid and the lamp-cup can be secured by a bolt and a nut.

5. An LED lamp of claim 1, wherein the insulating layer is positioned between the lamp-cap and the metal lamp-cup.
